(19) United States
(12) Patent Application Publication
(10) Pub. No.: US 2024/0247610 A1
(43) Pub. Date: Jul. 25, 2024

(54) An Organic Rankine Cycle (ORC) Power Generation System Utilizing LNG Cold Energy and Dual-fuel Marine Engine Waste Heat

(71) Applicant: Shanghai Maritime University, Shanghai (CN)

(72) Inventors: Zhen Tian, Shanghai (CN); Wenzhong Gao, Shanghai (CN); Yuan Zhang, Shanghai (CN); Leping Xu, Shanghai (CN)

(21) Appl. No.: 17/045,019

(22) PCT Filed: Jul. 2, 2019
(86) PCT No.: PCT/CN2019/094302

§ 371 Date: Aug. 6, 2021

(30) Foreign Application Priority Data
Oct. 11, 2018 (CN) 201811180495.5

(51) Int. Cl. F02C 1/05

(52) U.S. Cl. CPC F02C 1/05

(57) ABSTRACT

The present invention discloses an organic Rankine cycle (ORC) power generation system with a regenerator utilizing Liquefied Natural Gas (LNG) cold energy and industrial waste heat, the system comprising: an LNG regasification circuit, an ORC circuit, and an industrial waste heat circuit. The ORC circuit utilizes the cold energy released by the LNG regasification circuit and the heat energy dispersed by the industrial waste heat circuit. A bypass is set up in the ORC circuit to adjust the working medium flow rate via the expander to ensure efficient operation of the system. The invention improves the LNG cold energy recovery method based on the existing ORC cycle. The three-fluid heat exchanger and the regenerator could make full use of the cold energy provided by the LNG regasification process, reduce the thermal stress caused by the large temperature difference, alleviate the working load of the evaporator, and thus improve the heat to electricity conversion efficiency. The present invention is widely applicable in the fields of LNG cold power generation and industrial waste heat recovery.

### FIELD OF THE INVENTION

The present invention relates to the field of power engineering, relates to an LNG cold energy and industrial waste heat recovery system, and relates in particular to an organic Rankine cycle (ORC) power generation system based on a three-fluid heat exchanger and a regenerator.

### BACKGROUND ART

Liquefied Natural Gas (LNG) is clean primary energy. The utilization of LNG is in line with the development direction of international and China's energy structure optimization and low-carbon economy. Besides, global climate change and greenhouse gas emission control have further promoted the development of LNG. LNG is easy to store and transport, but it must be re-gasified before it can be used. The storage temperature of LNG is −162° C., while the required gas temperature is around or above 20° C. The cold energy of LNG released during the regasification process is about 830 KJ/kg.

The Organic Rankine Cycle (ORC) is able to use the cold energy and waste heat generated in industrial production and to convert them into electricity, which is easy for storage and transportation. This technology conforms to the policy requirements of sustainable development. However, the single-stage ORC power generation system confronts difficulties such as large temperature difference heat transfer, large irreversible loss and low system efficiency, which are the main factors impeding popularization and application of LNG cold power generation project. The aim of the present invention is to make full use of the high-grade cold energy and reduce the irreversible loss of the ORC power generation system.

The Chinese invention patent CN 107605555A discloses a power generation system coupled with two ORC systems, wherein the system thermal efficiency is improved by recovering the waste heat of the expander exhaust steam. The heat source involved in the system is industrial waste heat at medium and low temperature, but the property of the cold source is not defined. The cold energy utilization of LNG is not involved.

As described in U.S. Pat. No. 7,574,856B2, a two-stage ORC power generation system based on LNG cold energy utilization is disclosed wherein LNG flows through the first-stage ORC circulation loop and the second-stage ORC circulation loop successively to provide cold energy for working medium condensation. In particular, a regenerator is set in front of the evaporator in the first-stage ORC circulation loop to make full use of the working medium heat of the expander outlet. Although the system considers the full use of energy, the two-stage ORC power generation system has a complex structure. Moreover, the thermal stress caused by the large temperature difference between LNG and the circulation working medium is not considered.

Therefore, it is imperative to provide an efficient ORC power generation system that can solve the above technical problems and is suitable for LNG cold energy and industrial waste heat recovery.

### SUMMARY OF THE INVENTION

The present invention provides an ORC power generation system with a regenerator, which is suitable for LNG cold energy and industrial waste heat recovery. The ORC power generation system could effectively recover the cold energy in the LNG regasification process, reduce the thermal stress caused by the large temperature difference, decrease the irreversible loss, alleviate the working load of evaporator, and thus improve the heat to electricity conversion efficiency, which has significant economic and social benefits and is in line with the basic national policy of energy conservation and emission reduction.

The technical solution of present invention is as follows:

An ORC power generation system with a regenerator based on LNG cold energy and industrial waste heat recovery is disclosed. The ORC power generation system comprises an LNG regasification circuit, an ORC circuit, and an industrial waste heat circuit. Wherein, the ORC circuit utilizes the cold energy released by the LNG regasification circuit via the three-fluid heat exchanger and regenerator, and the ORC circuit utilizes the heat supplied by the industrial waste heat circuit via the evaporator.

The LNG regasification circuit comprises an LNG storage tank, an LNG circulation pump, a flow rate regulating valve, and a three-fluid heat exchanger, which are successively connected in that order. The LNG regasification circuit and the ORC circuit conduct heat exchange via the three-fluid heat exchanger. The mass flow rate in the LNG regasification circuit is determined according to the demand of end-users and is controlled by a flow rate regulating valve.

The ORC circuit is a closed cycle and comprises successively an expander, an electric generator, a gas-liquid separator, a regenerator, a three-fluid heat exchanger, a working medium circulation pump, a liquid reservoir, and an evaporator. A temperature sensor and a pressure sensor are both installed at the inlet and outlet of the expander. The exhaust steam of the expander enters the regenerator for precooling and then enters the three-fluid heat exchanger for primary condensation. The working medium that has been primarily condensed is pressurized by the working medium circulation pump and then enters the liquid reservoir. The working medium in turn enters the three-fluid heat exchanger, the regenerator and the evaporator and becomes high-temperature and high-pressure steam, which pushes the expander to drive the generator and to convert the mechanical energy into electricity.

A bypass pipe parallel to the expander is set up in the ORC circuit, and the mass flow rate of the working medium is controlled by the bypass valve.

The industrial waste heat circuit comprises successively an evaporator and a coolant circulation pump.

The three-fluid heat exchanger is the condenser of the ORC circuit, and the three-fluid heat exchanger is in wound tube type. The first fluid of the three-fluid heat exchanger is LNG, and the second fluid and the third fluid are ORC working medium. The ORC working medium flows through the three-fluid heat exchanger twice.

The regenerator and evaporator are plate heat exchangers. In the regenerator, heat exchange is conducted between ORC working medium with high-temperature and low-pressure and ORC working medium with low-temperature and high-pressure. In the evaporator, the coolant in the industrial waste heat circuit exchanges heat with the ORC working medium with low-temperature and high-pressure that comes from the regenerator.

The heat source of the ORC circuit is industrial waste heat, and its temperature range is 50° C.˜80° C.

The working medium of the ORC circuit is a mixture of methane, ethane, and propane.

The present invention has the following advantages: 1. The present invention makes full use of the high-grade cold energy and industrial waste heat released in the LNG regasification process, and the cold and heat energy are converted into electricity by means of the ORC power generation system. Consequently, heat pollution is alleviated, energy efficiency is improved and thus the operation cost of LNG is reduced. 2. A regenerator is adopted to preheat the working medium before entering the evaporator by using the working medium heat at the expander outlet, which not only improves the evaporation temperature of the ORC circuit but also reduces the working load of the evaporator; thus the overall efficiency of the ORC power generation system is improved. 3. The present invention employs the three-fluid heat exchanger as the condenser of the ORC power generation system, wherein LNG flows through the three-fluid heat exchanger for heat exchange with the ORC working medium; in the three-fluid heat exchanger, the LNG after absorbing heat is converted into natural gas suitable for end-user consumption, while the ORC working medium after releasing heat is condensed into saturated liquid. In particular, the ORC working medium flows through the three-fluid heat exchanger twice, and the temperature on each cross-section of the three-fluid heat exchanger is consistent, which eliminates the thermal stress caused by the large temperature difference and ensures the operation safety of the heat exchanger; meanwhile, the load of the evaporator in the ORC circuit is reduced, and the efficiency of the ORC power generation system is further improved. 4. The present invention employs the mixture of methane, ethane, and propane as the ORC working medium; by adjusting the proportion of each component, the condensation curve of the ORC working medium can match the regasification curve of LNG, thereby reducing the irreversible loss in the heat exchange process and improving the efficiency of the ORC power generation system. 5. In the present invention, a temperature sensor and a pressure sensor are both arranged before and after the expander, and the measured signals can be transmitted to the central controller in time to realize the intelligent control of the ORC power generation system; the bypass pipeline parallel to the expander ensures the reliability, safety, and stability of the system operation, which is convenient for the project implementation. The invention is simple in structure and is widely applicable in the field of LNG cold energy utilization.

### BRIEF DESCRIPTION OF THE DRAWINGS

FIG. 1 is a schematic diagram of an exemplary configuration of the present invention.

Wherein, 101 stands for an LNG storage tank, 102 stands for an LNG circulation pump, 103 stands for an LNG flow rate regulating valve; 201 stands for an expander, 202 stands for an electric generator, 203 stands for a liquid-vapor separator, 204 stands for a regenerator, 205 stands for a three-fluid heat exchanger, 206 stands for a working medium circulation pump, 207 stands for a liquid reservoir, 208 stands for an evaporator, 209 stands for a bypass valve, and 301 stands for a coolant circulation pump.

FIG. 2 is a schematic diagram of temperature-enthalpy (t-h) for the ORC power generation system with a regenerator.

Wherein, a denotes an inlet for LNG, b denotes an outlet for LNG, c denotes the first working medium inlet of the three-fluid heat exchanger, d denotes the first working medium outlet of the three-fluid heat exchanger, e denotes the second working medium inlet of the three-fluid heat exchanger, f denotes the second working medium outlet of the three-fluid heat exchanger, g denotes the working medium inlet of the evaporator, h denotes the working medium outlet of the evaporator, g′ denotes the working medium inlet of the evaporator without the regenerator, and h′ denotes the working medium outlet of the evaporator without the regenerator.

### DETAILED DESCRIPTION OF A PREFERRED EMBODIMENT

The technical solution of the present invention is further described in combination with the preferred embodiments and the attached drawings.

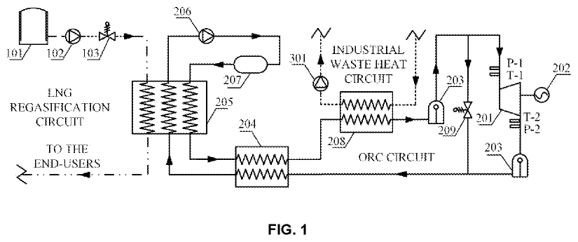

As shown in FIG. 1, the present invention relates to an ORC power generation system with a regenerator based on LNG cold energy and industrial waste heat recovery, which comprises an LNG regasification circuit, an ORC circuit, and an industrial waste heat circuit. Wherein, the cold source of the ORC circuit is supplied by the cold energy released by the LNG regasification circuit and the heat source thereof supplied by the industrial waste heat circuit.

In a preferred embodiment, the LNG regasification circuit comprises successively an LNG storage tank 101, an LNG circulation pump 102, an LNG flow rate regulating valve 103 and a three-fluid heat exchanger 205. The LNG regasification circuit and the ORC circuit conduct heat exchange via the three-fluid heat exchanger 205. The mass flow rate in the LNG regasification circuit is determined according to the demand of end end-users and is controlled by a flow rate regulating valve 103.

In a preferred embodiment, the ORC circuit is a closed cycle and comprises successively an expander 201, an electric generator 202, a gas-liquid separator 203, a regenerator 204, the three-fluid heat exchanger 205, a working medium circulation pump 206, a liquid reservoir 207 and an evaporator 208. Temperature sensors (T-1, T-2) and pressure sensors (P-1, P-2) are installed at the inlet and outlet of the expander 201. The exhaust steam of the expander 201 enters the regenerator 204 for precooling and then enters the three-fluid heat exchanger 205 for primary condensation. The working medium that has been primarily condensed is pressurized by the working medium circulation pump 206 and then enters the liquid reservoir 207. The working medium in turn enters the three-fluid heat exchanger 205, the regenerator 204 and the evaporator 208 to become high-temperature and high-pressure steam, which pushes the expander 201 to drive the generator 202 and thus to convert the mechanical energy into electricity.

In a preferred embodiment, a bypass pipe parallel to the expander is set up in the ORC circuit, and the mass flow rate of the working medium of the expander 201 is controlled by the bypass valve 209.

In a preferred embodiment, the industrial waste heat circuit comprises successively an evaporator 208 and a coolant circulation pump 301.

In a preferred embodiment, the three-fluid heat exchanger 205 is the condenser of the ORC circuit, and the three-fluid heat exchanger 205 is in wound tube type. The first fluid of the three-fluid heat exchanger 205 is LNG, and the second fluid and the third fluid are ORC working medium. The ORC working medium flows through the three-fluid heat exchanger 205 twice.

In a preferred embodiment, the regenerator 204 and the evaporator 208 are plate heat exchangers. In the regenerator 204, heat exchange is conducted between the ORC working medium with high-temperature and low-pressure and the ORC working medium with low-temperature and high-pressure. In the evaporator 208, the coolant for the industrial waste heat circuit exchanges heat with the ORC working medium with low-temperature and high-pressure that comes from the regenerator 204.

In a preferred embodiment, the heat source of the ORC circuit is industrial waste heat, with a temperature range of 50° C.˜80° C.

In a preferred embodiment, the working medium of the ORC circuit is a mixture of methane, ethane, and propane.

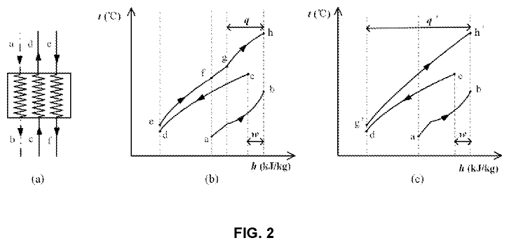

As shown in FIG. 2 (a), the working medium in the three-fluid heat exchanger are LNG, ORC working medium, and ORC working medium, respectively. As shown in FIG. 2 (b), for the ORC power generation system with a regenerator, the working load of the evaporator is q, the output work of the expander is w, and the system efficiency is defined as w/q. As shown in FIG. 2 (c), for the ORC power generation system without a regenerator, the working load of the evaporator is q′, the output work of the expander is w, and the system efficiency is defined as w/q′. On the premise that the output work of the expander is constant, the working load q is smaller than q′. Thus, the efficiency of the ORC power generation system with a regenerator is drastically improved.

Thus, the afore-mentioned preferred embodiments have been disclosed, which are not meant to limit the scope of the present invention. The various changes and modifications made by a person of the art according the technical solution and inventive concepts shall fall within the scope of the present invention.

1. An ORC power generation system with a regenerator for utilization of LNG cold energy and industrial waste heat, comprising an LNG regasification circuit, an ORC circuit, and an industrial waste heat circuit; wherein, the ORC circuit utilizes the LNG cold energy released by the LNG regasification circuit via a three-fluid heat exchanger and the regenerator, and the ORC circuit utilizes the industrial waste heat of the industrial waste heat circuit via an evaporator.

2. The ORC power generation system with the regenerator for utilization of LNG cold energy and industrial waste heat of claim 1, wherein the LNG regasification circuit comprises sequentially an LNG storage tank, an LNG circulation pump, a flow rate regulating valve and a three-fluid heat exchanger.

3. The ORC power generation system with the regenerator for utilization of LNG cold energy and industrial waste heat of claim 1, wherein the ORC circuit comprises an expander, an electric generator, a gas-liquid separator, the regenerator, a three-fluid heat exchanger, a working medium circulation pump, a liquid reservoir and an evaporator, which are connected successively in that order and form a closed cycle; a temperature sensor and a pressure sensor are both installed at an inlet and an outlet of the expander; exhaust steam of the expander enters the regenerator for precooling and then enters the three-fluid heat exchanger for primary condensation; working medium that has been primarily condensed is pressurized by the working medium circulation pump and then enters the liquid reservoir; working medium in turn enters the three-fluid heat exchanger, the regenerator and the evaporator and becomes high-temperature and high-pressure steam, which pushes the expander to drive the generator and thus converting mechanical energy into electricity; a bypass pipe parallel to the expander is set up in the ORC circuit for controlling the mass flow rate of the working medium.

4. The ORC power generation system with the regenerator for utilization of LNG cold energy and industrial waste heat of claim 1, wherein the industrial waste heat circuit comprises an evaporator and a coolant circulation pump connected successively.

5. The ORC power generation system with the regenerator for utilization of LNG cold energy and industrial waste heat of claim 1, wherein the three-fluid heat exchanger is a condenser in wound tube type of the ORC circuit, with LNG as a first fluid of the three-fluid heat exchanger, and the ORC working medium as a second fluid and a third fluid thereof.

6. (canceled)

7. The ORC power generation system with the regenerator for utilization of LNG cold energy and industrial waste heat of claim 2, wherein the three-fluid heat exchanger is a condenser in wound tube type of the ORC circuit, with LNG as a first fluid of the three-fluid heat exchanger, and the ORC working medium as a second fluid and a third fluid thereof.

8. The ORC power generation system with the regenerator for utilization of LNG cold energy and industrial waste heat of claim 3, wherein the three-fluid heat exchanger is a condenser in wound tube type of the ORC circuit, with LNG as a first fluid of the three-fluid heat exchanger, and the ORC working medium as a second fluid and a third fluid thereof.

9. The ORC power generation system with the regenerator for utilization of LNG cold energy and industrial waste heat of claim 1, wherein the regenerator and the evaporator are plate heat exchanger; heat exchange in the regenerator occurs between ORC working medium with high-temperature and low-pressure and ORC working medium with low-temperature and high-pressure; in the evaporator, the coolant for the industrial waste heat circuit exchanges heat with the ORC working medium with low-temperature and high-pressure that comes from the regenerator.

10. The ORC power generation system with the regenerator for utilization of LNG cold energy and industrial waste heat of claim 2, wherein the regenerator and the evaporator are plate heat exchanger; heat exchange in the regenerator occurs between ORC working medium with high-temperature and low-pressure and ORC working medium with low-temperature and high-pressure; in the evaporator, the coolant for the industrial waste heat circuit exchanges heat with the ORC working medium with low-temperature and high-pressure that comes from the regenerator.
